(19) United States
(12) Patent Application Publication
(10) Pub. No.: US 2015/0268865 A1
(43) Pub. Date: Sep. 24, 2015

(54) METHODS AND SYSTEMS FOR CALCULATING THE COST OF LOGICAL CAPACITY CONTAINERS

(71) Applicant: VMWARE, INC., Palo Alto, CA (US)

(72) Inventors: PIYUSH BHARAT MASRANI, Bangalore (IN); Kumar Gaurav, Bangalore (IN); Amarnath Palavalli, Bangalore (IN); Akshay Prabhakar Mirajkar, Bangalore (IN); Nikhil Dhankani, Bangalore (IN)

(73) Assignee: VMWARE, INC., Palo Alto, CA (US)

(21) Appl. No.: 14/267,923

(22) Filed: May 2, 2014

(30) Foreign Application Priority Data
Mar. 18, 2014 (IN) 1427/CHE/2014

(51) Int. Cl. G06F 3/06

(52) U.S. Cl. CPC G06F 3/0608; G06F 3/0689; G06F 3/0665

(57) ABSTRACT

The disclosure presents methods and systems for determining cost allocation for logical containers run on a data-center infrastructure. In one aspect, for each resource allocated to one or more logical containers, a method calculates a resource allocation value for each of the one or more logical containers, the resource allocation value represents an amount of the resource allocated to the logical container. An allocated container cost is then calculated for each of the one or more logical containers based on the resource allocation value of each logical container. A cost of unused portions of the resource for each of the one or more logical containers is calculated based on the allocated container cost and the resource allocation value associated with each logical container. The resource allocation value, the allocated container cost, and the cost of unused portion of the resource are stored in one or more data-storage devices.

### RELATED APPLICATIONS

Benefit is claimed under 35 U.S.C. 119(a)-(d) to Foreign application Serial No. 1427/CHE/2014 filed in India entitled “METHODS AND SYSTEMS FOR CALCULATING THE COST OF LOGICAL CAPACITY CONTAINERS”, filed on Mar. 18, 2014, by VMware. Inc., which is herein incorporated in its entirety by reference for all purposes.

### TECHNICAL FIELD

The present disclosure is directed to calculating the cost of logical capacity containers carved out of a virtual data center.

### BACKGROUND

A data center is a facility that houses servers and data-storage devices and other associated components including backup power supplies, redundant data communications connections., environmental controls, such as air conditioning and fire suppression, and includes various security systems. A data center is typically maintained by an IT service provider. An enterprise purchases data storage and data processing services from the provider in order to run applications that handle the enterprises' core business and operational data. The applications may be proprietary and used exclusively by the enterprise or made available through a network for anyone to access and use.

In recent years, virtual machines (“VMs”) have been introduced to lower data center capital investment in facilities and operational expenses and reduce energy consumption. A VM is a software implementation of a computer that executes application software just like a physical computer. VMs have the advantage of not being bound to physical resources, which allows VMs to be moved around and scaled up or down to meet the changing demands of the enterprise without affecting use of the enterprise's applications. VMs can be used to form virtual data centers (“VDCs”) composed of virtual servers and virtual storage. For a typical VDC, it is common practice to allocate and reserve resources carved out of a data-center infrastructure layer to a user or user group without regard to whether the VMs have been created by the user or not. These logical entities of allocated resources are called “containers.” A container is a multi-dimensional logical entity composed of certain units of processing power, memory, storage, and network. However, determining the cost of a container is often challenging: 1) Because a container is a logical abstraction over the data-center infrastructure, infrastructure unit rates of cost consumption cannot be directly applied. 2) A container may also be created out of a parent container with a possibility of further division into children containers, which adds to the complexity. 3) A container can also commit more resources than the underlying layer provides, which adds to further complexity in arriving at the container's true cost. Enterprises that purchase IT services and IT service providers seek efficient methods and systems for assessing the cost of containers.

### SUMMARY

The disclosure presents methods and systems for determining cost allocation for logical containers run on a data-center infrastructure. In one aspect, for each resource allocated to one or more logical containers, a method calculates a resource allocation value for each of the one or more logical containers, the resource allocation value represents an amount of the resource allocated to the logical container. An allocated container cost is then calculated for each the one or more logical containers based on the resource allocation value of each logical container. A cost of unused portions of the resource for each of the one or more logical containers is calculated based on the allocated container cost and the resource allocation value associated with each logical container. The resource allocation value, the allocated container cost and the cost of unused portion of the resource are stored in one or more data-storage devices.

### DESCRIPTION OF THE DRAWINGS

FIG. 1 shows an example of a generalized computer system that executes efficient methods for determining cost allocation for a number of containers run on a data-center infrastructure.

FIG. 2 shows an example of a data center and an example of logical containers.

FIG. 3 displays a table of resource allocation functions for six different physical data-center resources.

FIG. 4 shows example containers allocated for different portions of memory of one or more servers.

FIG. 5 shows a table of three example service agreements with limits, reservations, and utilizations of memory for three different containers.

FIG. 6 shows a summary of allocated and unallocated costs for three example containers.

FIG. 7 shows a flow-control diagram of a method fir determining cost associated with containers.

### DETAILED DESCRIPTION

This disclosure presents computational methods and systems for calculating costs associated with containers in order to prevent over and under allocation of resources and justify cost distribution. Methods and systems described below provide efficient computational mathematical tools for determining allocated cost of resource used by each container, cost of unallocated portions of a resource, cost of unused portions of a resource, other allocated and unallocated cost that aid in assessing over and under allocation of resources to containers.

It should be noted at the onset that data related to calculating allocated and unallocated container costs is not, in any sense, abstract or intangible. Instead, the data is necessarily digitally encoded and stored in a physical data-storage computer-readable medium, such as an electronic memory, mass-storage device, or other physical, tangible data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems on electronically or magnetically stored data, with the results of the data processing and data analysis digitally encoded and stored in one or more tangible, physical, data-storage devices and media.

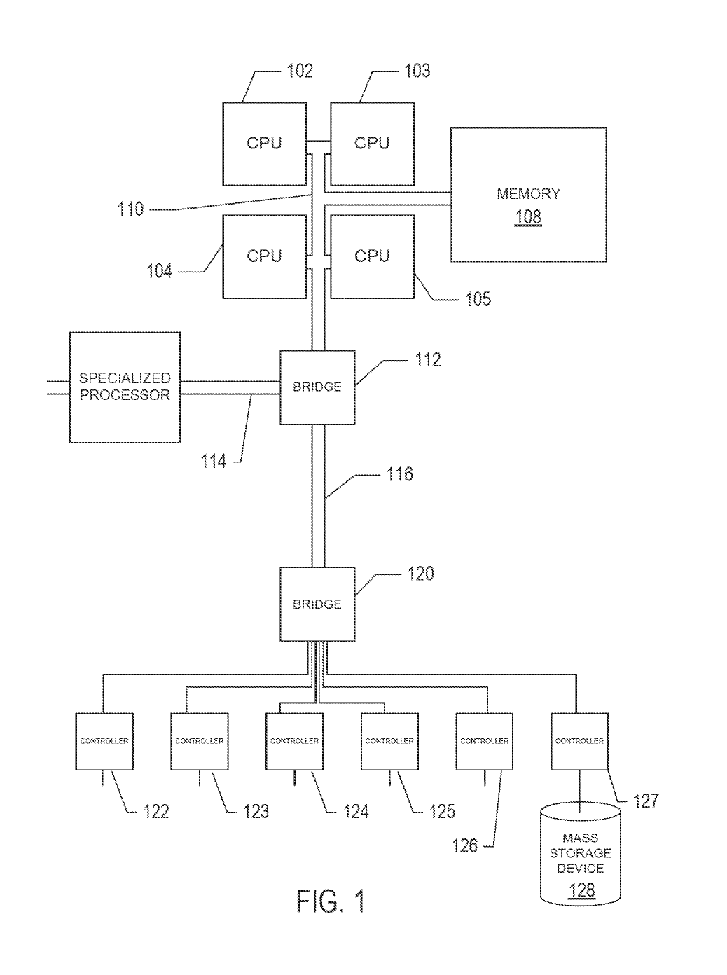

FIG. 1 shows an example of a generalized computer system that executes efficient methods for calculating the cost of containers and therefore represents a data-processing system. The internal components of many small, mid-sized, and large computer systems as well as specialized processor-based storage systems can be described with respect to this generalized architecture, although each particular system may feature many additional components, subsystems, and similar, parallel systems with architectures similar to this generalized architecture. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. The busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of computer-readable media, such as computer-readable medium 128, electronic displays, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 128 is a data-storage device, including electronic memory, optical or magnetic disk drive, USB drive, flash memory and other such data-storage device. The computer-readable medium 128 can be used to store machine-readable instructions that encode the computational methods described below and can be used to store encoded data, during store operations, and from which encoded data can he retrieved, during read operations, by computer systems, data-storage systems, and peripheral devices.

Data centers house computer equipment, telecommunications equipment, and data-storage devices. A typical data center may occupy one room of a building, one or more floors of a building, or may occupy an entire building. Most of the computer equipment is in the form of servers stored in cabinets arranged in rows with corridors between the rows in order to allow access to the front and tear of each cabinet.

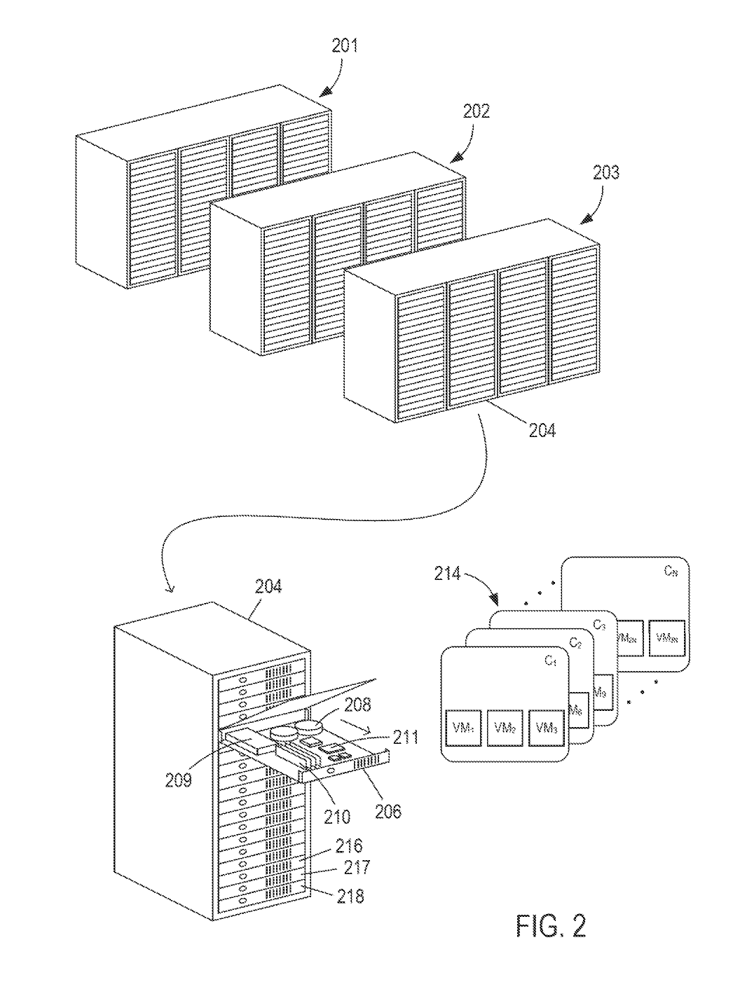

FIG. 2 shows an example of three rows of cabinets 201-203 in a data center. Each row includes four cabinets, such as cabinet 204, of vertically stacked boards. Each board is located on a tray that may be pulled out in order to access board components. A number of the boards may be configured as servers and other boards may be dedicated to telecommunications and/or configured with data-storage devices, such as hard disk drives, for storing and accessing large quantities of data. A server includes software and computer hardware arranged on a circuit board disposed on a tray of a cabinet. Each server is a host for one or more software applications that are used in a network environment. In the example of FIG. 2, the cabinet 204 is shown enlarged with a tray 206 pulled out from the cabinet 204 to access hardware components of a server. In this example, the server hardware components include a cooling system 208, data storage 209, memory 210, a processor 211, and any other electronic components, such as network cards.

Containers are composed of a number of virtual machines (“VMs”) and each container is allocated physical resources of the data-center infrastructure. For example, resources allocated to a container include processors, memory, data-storage devices, and network, just to name a few. The resources allocated to a container are not limited to just one server. A container may he allocated resources of any number of servers in the data center.

FIG. 2 shows an example of N logical containers 214, denoted by C₁, C₂, C₃, and C_{N}, each of which includes a number of virtual machines (“VMs”). Each of the containers C₁, C₂, C₃, and C_{N} is not limited to using the resources of one server in the data center. Instead, each of the containers C₁, C₂, C₃, and C_{N} uses allocated resources of the data center and the resources allocated to each container is not fixed and may change over time to improve computational efficiency, lower costs, and satisfy changing demands for resources. For example, in one computational time interval, container C₁ may be allocated the resources of server 206 while container C₂ may be allocated the resources of servers 216-218. In a subsequent time interval, container C₁ may be allocated the resources of the server 206 and the resources of another server while the number of resources allocated to container C₂ is reduced to the resources of servers 217 and 218. A record of how much of each resource a container uses is recorded over time.

Data-center users and IT service providers agree upon policies to be followed in defining logical container Cᵢ. Three common parameters used to define containers are reservation, limit, and priority. Reservation is the minimum amount of the resources which are guaranteed to be available for the container. Limit is the maximum amount of the resources that can be made available to the container provided the parent container/resource pool provides for a limit. Priority is the order in Which requests for resources may he allocated to the container, in the case of current requests from containers with different priorities and limited availability of the resources. In the case where resources are over committed to the containers, priority will he used for resource allocation. The different policy parameters- ensure a data-center user of quality and quantity of resources. The different policy parameters enable IP server providers to plan infrastructure needs based on requests and provide adequate services. The policy parameters enable a service provider to charge users fairly. In particular, service providers may be able to charge users not only on their utilization of various resources, but may also be able to charge based on policies chosen by the user while getting access to the resources.

Methods and systems for determining allocated and unallocated costs associated with containers are now described. In the follow discussion, the cost of a data-center resource is denoted by cᵣ and a total capacity for the resource is denoted by Tᵣ, where the subscript r is a physical data-center resource index. For example, the cost of six data-center resources are represented by c_{proc}, cₘₑₘ, cₛₜₒᵣ, c_{Net}_{_{—}}ₛₚ, c_{Net}_{_{—}}ₜᵣₐₙₛ, and c_{IOPs}, where c_{proc} is the cost of one or more processor(s); cₘₑₘ is the cost of memory: cₛₜₒᵣ is the cost of data-storage devices: C_{Net}_{_{—}}ₛₚ is the cost of using a network; c_{Net}_{_{—}}ₜᵣₐₙₛ is the cost of transmitting data over the network; and c_{IOPs} is the input/output costs of data-storage devices. Note that this list of costs associated with data-center resources is merely a representative list and it is not intended to be an exhaustive list of all the different costs of resources of a data center that may be allocated to logical containers.

Methods also use a resource allocation function for a container Cᵢ denoted by fᵣ (Cᵢ).. A resource allocation function for a resource used by a container gives a numerical resource allocation value that represents an amount of a resource allocated to the container. For example, a resource allocation function ƒᵣ(Cᵢ) may be a numerical value that represents utilization of the resource, denoted by util (Cᵢ), an agreed upon reservation of the resource denoted by res(Cᵢ), or a limit the amount of the resource that may be used denoted by limit(Cᵢ).

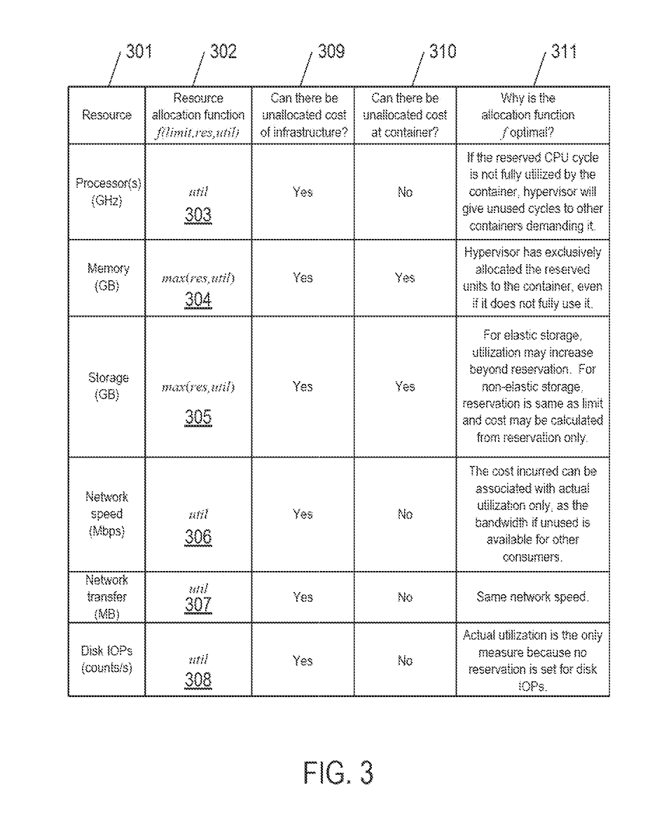

FIG. 3 displays a table of resource allocation functions for six different physical data-center resources that may be allocated to containers. Column 301 identifies six various physical resources that may be allocated to containers. Column 302 identifies the resource functions associated with corresponding resources listed in column 301. For example, table entry 303 indicates that the resource allocation function for processors allocated to a container Cᵢ is a numerical value that represents the container's utilization of the processors denoted by ƒᵣ(Cᵢ)=util(Cᵢ). For example, the container Cᵢ may use a processor with a processor speed of 3.5 GHz for 0.5 seconds, which corresponds to a resource allocation value of util(Cᵢ)=1.75. Table entries 304 and 305 indicate that the resource allocation functions for memory and storage allocated to the container is the maximum of the container's reservation and utilization denoted by ƒᵣ(Cᵢ)=max(res(Cᵢ), util(Cᵢ)). For example, a container may have 200 GB of storage reserved but the container actually utilizes 100 GB. In this example, the resource allocation function for storage gives a resource allocation value of max(res(Cᵢ), util(Cᵢ))=200 GB for the container. Table entries 306-308 indicate that the resource allocation functions for network speed, network transfer, and disk IOPs are all functions of the container's utilization of these resources. Yes and no entries in column 309 indicate whether or not there are any unallocated costs associated with the resources listed in column 301. Yes and no entries in column 310 indicate whether or not there are unallocated costs associated with the resources listed in column 301 for a container. And entries in column 311 provide an explanation for why the allocation functions listed in column 302 are optimal. Note that the list of resources and resource allocations displayed in FIG. 3 is merely a representative list of data-center resources that may be allocated to logical containers and is not intended to be an exhaustive list of all the different data-center resources allocated to the container and associated resource allocation functions.

Methods and systems calculate various cost and capacity parameters associated with a container. These parameters now described may be used to calculate costs associated with each container in order to prevent over and under allocation of resources and justify cost distribution. In particular, methods and systems now described may be used to calculate a total cost of all the containers running on the servers, total unallocated container cost for all the containers, and a total cost for unallocated server resources.

As described above, a resource allocation function ƒᵣ(Cᵢ) gives a resource allocation value that represents the amount of the resource r allocated to a container Cᵢ. Summing ƒᵣ(Cᵢ) for all N containers allocated use of the resource r gives a total allocation of the resource r to the N containers:

$${A}_{r} = {\sum }_{i = 1}^{N} {f}_{r} ( {C}_{i} ) \qquad ( 1 )$$

Subtracting the total allocation of the resource r to the N containers given in Equation (1) from the total capacity of the resource Tᵣ gives a total unallocated capacity for the resource r:

Uᵣ=Tᵣ−Aᵣ (2)

The total unallocated resource capacity Uᵣ, resource cost Cᵣ, and total capacity of the resource Tᵣ may he used to calculate a cost of the total unallocated capacity of the resource r:

$${Uc}_{r} = \frac{{c}_{r} \cdot {U}_{r}}{{T}_{r}} \qquad ( 3 )$$

Allocated container cost for a resource r used by a container Cᵢ may be calculated from the resource allocation function ƒᵣ(Cᵢ). The cost of a resource Cᵣ, and the total capacity of the resource Tᵣ as follows:

$${cc}_{r} ( {C}_{i} ) = \frac{{c}_{r} \cdot {f}_{r} ( {C}_{i} )}{{T}_{r}} \qquad ( 4 )$$

The portion of the resource r that is riot used by the container cᵢ is given by an unallocated container capacity:

Uᵣ(Cᵢ)=ƒᵣ(Cᵢ)−utilᵣ(Cᵢ) (5)

The unallocated container capacity Uᵣ(Cᵢ), the resource allocation function ƒᵣ(Cᵢ), and the allocated container cost ccᵣ(Cᵢ) are used to calculate the cost of unused portions the resource r allocated to the container Cᵢ:

$${Ucc}_{r} ( {C}_{i} ) = \frac{{cc}_{r} ( {C}_{i} ) \cdot {U}_{r} ( {C}_{i} )}{{f}_{r} ( {C}_{i} )} \qquad ( 6 )$$

The allocated container cost ccᵣ(Cᵢ) of each resource calculated according to Equation (4) may be summed for all of the resources allocated to the container Cᵢ to give a total cost of all the resources r allocated to the container Cᵢ:

$$cc ( {C}_{i} ) = {\sum }_{r} {cc}_{r} ( {C}_{i} ) \qquad ( 7 )$$

On the other hand, the unallocated container cost of each resource calculated according to Equation (6) may be summed for all of the resource to give a total cost of all the unused portions resources r allocated to the container Cᵢ:

$$Ucc ( {C}_{i} ) = {\sum }_{r} {Ucc}_{r} ( {C}_{i} ) \qquad ( 8 )$$

Summing the cost for all of the unallocated resources r calculated according to Equation (8) gives a total cost of all unallocated resources:

$$UC = {\sum }_{r} {Uc}_{r} \qquad ( 9 )$$

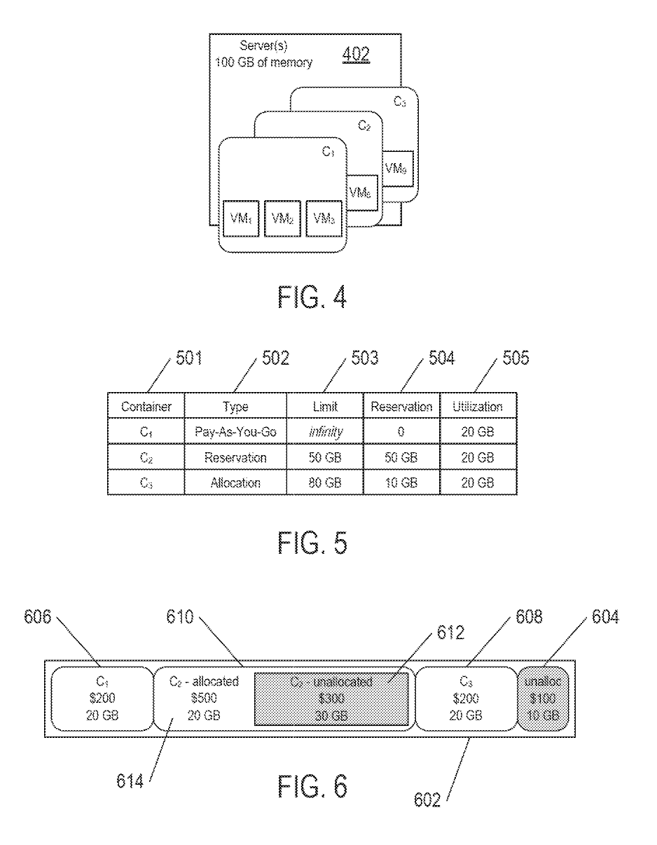

An example of using Equations (1)-(9) to calculate container costs, unallocated container capacity, and unallocated container costs for three example containers sharing the same memory resource are now described with reference to FIGS. 4-6. FIG. 4 shows three example containers C₁, C₂, and C₃ that are each allocated different portions of 100 GB of memory of one or more servers 402 according to different IT service agreements with an IT service provider. In other words. The resource r in this example is memory and the total capacity of the resource shared by the three containers is Tₘₑₘ=100 GB. For the sake of convenience and simplicity, assume that the amortized monthly cost of the memory is $1,000 (i.e., cₘₑₘ=$1,000).

FIG. 5 shows a table of three different types of agreements regarding limits, reservation, and utilization of the 100 GB of memory for the three different containers C₁, C₂, and C₃ Column 501 list the three different containers C₁, C₂, and C₃. Column 502 lists the three different types of agreements. The user of container C₁ has a “pay-as-you-go” agreement with the IT service provider; the user of container C₂ has a “reservation” agreement with the IT service provider; and the user of container C₃ has an “allocation” agreement with the IT service provider. Column 503 list the memory limits associated with each container. Column 504 list the amount of memory reserved for each container. And column 506 list the amount of memory each container actual utilized.

The containers, agreements, limits, reservations, and actual utilization of the memory are selected to demonstrate that when there are a number of permutations for allocating the cost of a resource to containers, certain containers may end up over-allocating or under-allocating the resource. This particular example demonstrates how to determine the unallocated cost of a resource remaining at the server level as well as the container level. This example will also demonstrate use of the resource allocation function for memory described above with reference to table entry 304 in FIG. 3. The particular function is suitable because hypervisor does not allow other containers use of any unused portion of a reserved resource. In other words, hypervisor maintains Σᵢ₌₁^{N}res(Cᵢ)≦Tᵣ, where res(Cᵢ) is the amount of a resource reserved to the container Cᵢ.

Begin by calculating the allocation of memory to each of the containers according to the resource allocation function given in table entry 305 of FIG. 3 and the data given in columns 504 and 505 as follows:

ƒₘₑₘ(C₁)=max(0,20)=20 GB

ƒₘₑₘ(C₂)=max(50,20)=50 GB

ƒₘₑₘ(C₃)=max(10,20)=20 GB

Summing ƒₘₑₘ(C₁), ƒₘₑₘ(C₂), and ƒₘₑₘ(C₃) according to Equation (1) gives 90 GB as the total allocation of memory to the three containers. According to Equation (2), the total unallocated resource capacity is

$${U}_{mem} = {T}_{mem} - {\sum }_{i = 1}^{3} {f}_{mem} ( {C}_{i} ) = 100 GB - 90 GB = 10 GB$$

In other words, 10 GB or 10% of the 100 GB of memory on one or more servers 402 is not allocated. According to Equation (3), the cost of the 10 GB unallocated portion of the 100 GB of memory is

$${Uc}_{mem} = \frac{{c}_{mem} \cdot {U}_{mem}}{{T}_{mem}} = \frac{\$1 , 000 \cdot 10 GB}{100 GB} = \$100$$

The cost of the unallocated portion of the memory Ucₘₑₘ=$100 may be viewed by the IT service provider as under allocating the total memory capacity. Equation (4) ma be used to calculate the allocated container cost of the memory to each of the containers as follows:

$${cc}_{mem} ( {C}_{1} ) = \frac{{c}_{mem} \cdot {f}_{mem} ( {C}_{1} )}{{T}_{mem}} = \frac{\$1 , 000 \cdot 20 GB}{100 GB} = \$200$$

$${cc}_{mem} ( {C}_{2} ) = \frac{{c}_{mem} \cdot {f}_{mem} ( {C}_{2} )}{{T}_{mem}} = \frac{\$1 , 000 \cdot 50 GB}{100 GB} = \$500$$

$${cc}_{mem} ( {C}_{3} ) = \frac{{c}_{mem} \cdot {f}_{mem} ( {C}_{3} )}{{T}_{mem}} = \frac{\$1 , 000 \cdot 20 GB}{100 GB} = \$200$$

Equation (5) may be used calculate the unutilized portion of the memory for each of the containers:

Uₘₑₘ(C₁)=20 GB−20 GB=0 GB

Uₘₑₘ(C₂)=50 GB−20 GB=30 GB

Uₘₑₘ(C₂)=20 GB−20 GB=0 GB

In this example, the container C₂ does not use all of the reserved memory by leaving 30 GB unused. The cost of unused portions of the memory for each container is calculated according to Equation (6) as follows:

$${Ucc}_{mem} ( {C}_{1} ) = \frac{{c}_{mem} ( {C}_{1} ) \cdot {U}_{mem} ( {C}_{1} )}{{f}_{mem} ( {C}_{1} )} = \frac{\$200 \cdot 0 GB}{100 GB} = \$0$$

$${Ucc}_{mem} ( {C}_{2} ) = \frac{{c}_{mem} ( {C}_{2} ) \cdot {U}_{mem} ( {C}_{2} )}{{f}_{mem} ( {C}_{2} )} = \frac{\$500 \cdot 30 GB}{50 GB} = \$300$$

$${Ucc}_{mem} ( {C}_{3} ) = \frac{{c}_{mem} ( {C}_{3} ) \cdot {U}_{mem} ( {C}_{3} )}{{f}_{mem} ( {C}_{3} )} = \frac{\$200 \cdot 0 GB}{20 GB} = \$0$$

The cost of unused reserved memory Uₘₑₘ(C₂)=30 GB for the container C₂ is U ccₘₑₘ(C₂)=$300.

FIG. 6 shows summarizes allocation and on allocation costs and capacities calculated above for the example containers C₁, C₂, and C₃. Box 602 represents the total capacity of the 100 GB of memory of the one or more servers 402. Block 604 represents Uₘₑₘ=10 GB of memory not allocated to the containers C₁, C₂, and C₃ and the associated cost U cₘₑₘ=$100 of not allocating this portion of the memory. In other words, the IT service provider would like to minimize this cost. Block 606 represents the allocated memory ƒₘₑₘ(C₁)=20 GB and the associated cost of the allocated memory ccₘₑₘ(C₁)=$200 for the container C₁. Block 608 represents the allocated memory ƒₘₑₘ(C₃)=20 GB and the associated cost of the allocated memory ccₘₑₘ(C₃)=$200 for the container C₃. Nov block 610 represents the allocation of memory fₘₑₘ(C₂)=50 GB for the container C₂. But unlike the containers C₁ and C₃, a portion Uₘₑₘ(C₂)=30 GB of the 50 GB of memory reserved for the container C₂ is not utilized as represented by shaded region 612 within block 610. The cost of this unutilized portion of the memory to an enterprise is Uccₘₑₘ(C₂)=$300. Unshaded portion of block 610 represents the utilized portion ƒₘₑₘ(C₁)=20 GB by the container C₂ of the memory but the cost to the enterprise of using container C₂ is ccₘₑₘ(C₂)=$500 and cost of unused memory Uccₘₑₘ=$300 reveals that the enterprise has paid $300 for the unused memory. In other words, the memory is over allocated to the container C₂.

It should be noted that the above described functions represented in Equations (1)-(9) and ways to distribute cost to containers in proportion to the resource allocation functions may be applied to nested containers. For example, Equations (1)-(9) may be applied to child containers carved out of a parent container.

It may be the case that the total capacities of certain data-cente resources are not available for full allocation to the containers. Instead a user or system defined “expected allocation” of certain resources it used, and the cost is allocated accorded to the expected allocation. For example, a resource r may have a total capacity Tᵣ, but the expected allocation of the resource is αTᵣ, where α is a resource allocation parameter and 0<α<1. This unallocated portion the resource (1−α)Tᵣ is called “buffer capacity,” which may be reserved to handle peak demands. When Σᵢ₌₁^{N}ƒᵣ(Cᵢ)≦αTᵣ, the buffer capacity, (1−α)Tᵣ, may be neglected. As a result, the total capacity Tᵣ of the resource available to the containers is reassigned to Tᵣ=αTᵣ, allocation of cost is performed in Equations (1)-(9) for Tᵣ=αTr, and there may he unallocated costs. On the other hand, when Σᵢ₌₁^{N}ƒᵣ(Cᵢ)>αTᵣ, the expected allocation αTᵣ may be neglected and the total capacity of the resource Tᵣ, is reset to the actual amount of the resource utilized by the containers, Tᵣ=Σᵢ₌₁^{N}ƒᵣ(Cᵢ). Cost allocation is performed using Equations (1)-(9) for Tᵣ=Σᵢ₌₁^{N}ƒᵣ(C₁) and there is no expectation of unallocated cost.

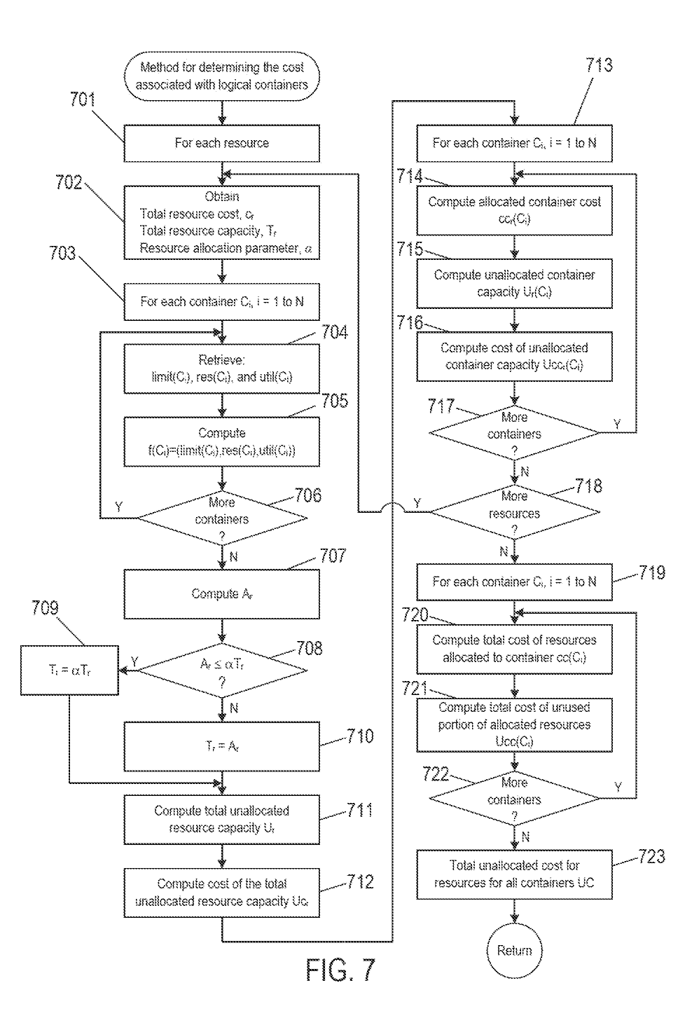

FIG. 7 shows a flow-control diagram of a method for determining cost associated with containers. A for-loop beginning in block 701 repeats the computational operations of blocks 702-718 for each of the resources of a data-center infrastructure allocated to N containers. In block 702, the method retrieves a total cost of a resource cᵣ, total capacity of the resource Tᵣ, and resource allocation parameter ζ. A for-loop beginning in block 703 repeats the computational operations of blocks 704-706 for each one of the N containers. In block 704, util(Cᵢ), res(Cᵢ) or limit(Cᵢ) are retrieved for a container depending on the type of resource as described above with reference to FIG. 3. In block 705, a resource allocation function ƒᵣ(Cᵢ) associated with the resource may be used to calculate a resource allocation value for the container Cᵢ, as described above with reference to FIG. 3. In block 706, when the operations in blocks 704 and 705 have been Carried out for all of the containers, the method proceeds to block 707. Otherwise, the method repeats the operations in blocks 704 and 705. In block 707, a total allocation of the resource Aᵣ to the N containers is calculated as described above with reference to Equation (1). In block 708, when the total allocation of the resource Aᵣ is less than or equal to the total capacity of the resource Tᵣ, the method proceeds to block 709. Otherwise, the method proceeds to block 710. In block 709, the total capacity of the resource available for allocation may be reset to Tᵣ=αTᵣ. In block 710, the total capacity of the resource available for allocation may be reset to =a1₁. In block 711, the total unallocated resource capacity Uᵣ may be calculated according to Equation (2). In block 712, the cost of the total unallocated resource capacity Ucᵣ may be calculated according to Equation (3). A for-loop in block 713 repeats the computational operations of blocks 714-717 for each of the N containers. In block 714, allocated container cost per container ccᵣ(Cᵢ) may be calculated according to Equation (4). In block 715, an unallocated container capacity Uᵣ(Cᵢ)may be calculated according to Equation (5) to obtain the amount of the resource not used by the container. In block 716, cost of the unallocated container capacity Uccᵣ(Cᵢ) may be calculated according to Equation (6). In block 717, when the operations in blocks 714-716 have been carried out for all of the containers, the method proceeds to block 718. Otherwise, the method repeats the operations in blocks 714-716. In block 718, the method repeats the operations of block 702-717 for all resources allocated to the N containers. Otherwise, the method proceeds to block 719. A for-loop in block 719 repeats the computational operations of blocks 720-722 for each of the N containers. In block 720, a total cost of resources allocated to a container cc(Cᵢ) may he calculated according to Equation (7). In block 721, a total cost of unused portions of resources allocated to the container Uccᵣ(Cᵢ) may be calculated according to Equation (8). In block 722, when the operations in blocks 720-721 have repeated for each of the N containers, control flows to block 723. Otherwise the operations in blocks 720-721 are repeated. In block 723, a total cost of unallocated resources UC may be calculated according to Equation (9).

Although various implementations have been described in terms of particular embodiments, it is not intended that the disclosure be limited to these embodiments. Modifications within the spirit of the disclosure will be apparent to those skilled in the art. For example, any of a variety of different implementations can be obtained by varying any of many different design and development parameters, including programming language, underlying operating system, modular organization, control structures, data structures, and other such design and development parameters.

It is appreciated that the previous description of the disclosed embodiments is provided to enable any person skilled in the art to make or use the present disclosure, Various modifications to these embodiments will be readily apparent to those skilled in the art, and the generic principles defined herein may be applied to other embodiments without departing from the spirit or scope of the disclosure. Thus, the present disclosure is not intended to he limited to the embodiments shown herein but is to be accorded the widest scope consistent with the principles and novel features disclosed herein.

1. A system for determining cost allocation for logical containers run on a data-center infrastructure, the system comprising:
one or more processors;
one or more data-storage devices; and
a routine stored in the data-storage devices and executed using the one or more processors, the routine executing, for each resource allocated to one or more logical containers,
calculating a resource allocation value for each of the one or more logical containers, the resource allocation value represents an amount of the resource allocated to the logical container;
calculating an allocated container cost for each of the one or more logical containers based on the resource allocation value of each logical container;
calculating a cost of unused portions of the resource for each of the one or more logical containers based on the allocated container cost and the resource allocation value associated with each logical container; and
storing the resource allocation value, the allocated container cost, and the cost of unused portion of the resource in the one or more data-storage devices.

2. The system of claim 1, wherein calculating the resource allocation value comprises calculating a numerical value resource allocation function that represents one of utilization of the resource or a reservation of the resource.

3. The system of claim 1, wherein calculating the allocated container cost of a logical container further comprises calculating the resource :allocation value multiplied by :a total cost of the resource divided by a total capacity of the resource.

4. The system of claim 1, wherein calculating the cost unused portions of the resource further comprises:
calculating an unallocated container capacity for the container; and
calculating the allocated container cost multiplied by the unallocated container capacity divided by the resource allocated value.

5. The system of claim 1 further comprises
for each logical container,
summing the allocated container cost of each resources to generate a total cost of resources allocated to the logical container; and
summing the cost of unused portions of each resource to generate a total cost of unused portions of allocated resources.

6. The system of claim 1 further comprises:
for each resource,
calculating a total unallocated resource capacity; and
calculating a cost of the total unallocated resource capacity based on the cost of resource and the total capacity of the resource.

7. A method stored in one or more data-storage devices and executed using one or more processors for determining cost allocation for logical containers run on a data-center infrastructure, the method comprising:
for each resource allocated to one or more logical containers,
calculating a resource allocation value for each of the one or more logical containers, the resource allocation value represents an amount of the resource allocated to the logical container;
calculating an allocated container cost for each of the one or more logical containers based on the resource allocation value of each logical container;
calculating a cost of unused portions of the resource for each of the one or more logical containers based on the allocated container cost and the resource allocation value associated with each logical container; and
storing the resource allocation value, the allocated container cost, and the cost of unused portion of the resource in one or more data-storage devices.

8. The method of claim 7, wherein calculating the resource allocation value comprises calculating a numerical value resource allocation function that represents one of utilization of the resource or a reservation of the resource.

9. The method of claim 7, wherein calculating the allocated container cost of a logical container further comprises calculating the resource allocation value multiplied by a total cost of the resource divided by a total capacity of the resource.

10. The method of claim 7, wherein calculating the cost of unused portions of the resource further comprises:
calculating an unallocated container capacity for the container; and
calculating the allocated container cost multiplied by the unallocated container capacity divided by the resource allocated value.

11. The method of claim 7 further comprises
for each logical container,
summing the allocated container cost of each resources to generate a total cost of resources allocated to the logical container; and
summing the cost of unused portions of each resource to generate a total cost of unused portions of allocated resources.

12. The method of claim 7 further comprises:
for each resource,
calculating a total unallocated resource capacity; and
calculating a cost of the total unallocated resource capacity based on the cost of resource and the total capacity of the resource.

13. A computer-readable medium encoded with machine-readable instructions that implement a method carried out by one or more processors of a computer system to perform the operations of
for each resource allocated to one or more logical containers,
calculating a resource allocation Value for each of the one or more logical containers, the resource allocation value represents an amount of the resource allocated to the logical container;
calculating an allocated container cost for each of the one or more logical containers based on the resource allocation value of each logical container;
calculating a cost of unused portions of the resource for each of the one or more logical containers based on the allocated container cost and the resource allocation value associated with each logical container; and
storing the resource allocation value, the allocated container cost, and the cost of unused portion of the resource in one or more data-storage devices.

14. The medium of claim 13, wherein calculating the resource allocation value comprises calculating a numerical value resource allocation function that represents one of utilization of the resource or a reservation of the resource.

15. The medium of claim 13, wherein calculating the allocated container cost of a logical container further comprises calculating the resource allocation value multiplied by a total cost of the resource divided by a total capacity of the resource.

16. The medium of claim 13, wherein calculating the cost of unused portions of the resource further comprises:
calculating an unallocated container capacity for the container; and
calculating the allocated container cost multiplied by the unallocated container capacity divided by the resource allocated value.

17. The medium of claim 13 further comprises
for each logical container,
summing the allocated container cost of each resources to generate a total cost of resources allocated to the logical container; and
summing the cost of unused portions of each resource to generate a total cost of unused portions of allocated resources.

18. The medium of claim 13 further comprises:
for each resource,
calculating a total unallocated resource capacity; and
calculating a cost of the total unallocated resource capacity based on the cost of resource and the total capacity of the resource.
